(19) United States
(12) Patent Application Publication
(10) Pub. No.: US 2026/0301645 A1
(43) Pub. Date: Oct. 1, 2026

(54) DISTRIBUTED DRIVE CIRCUIT, CONTROL METHOD AND DISPLAY DEVICE

(71) Applicant: HUAYUAN SEMICONDUCTOR (SHENZHEN) LIMITED COMPANY, Shenzhen, Guangdong (CN)

(72) Inventors: Junyue Sun, Shenzhen, Guangdong (CN); Yujun Wang, Shenzhen, Guangdong (CN); Yuanlei Wang, Shenzhen, Guangdong (CN); Yuting Fang, Shenzhen, Guangdong (CN); Xiang Xia, Shenzhen, Guangdong (CN)

(21) Appl. No.: 18/881,767

(22) PCT Filed: Apr. 21, 2023
(86) PCT No.: PCT/CN2023/089691

§ 371 Date: Jan. 7, 2025

(30) Foreign Application Priority Data
Aug. 16, 2022 (CN) 202210981375.5

(51) Int. Cl. G09G 3/32

(52) U.S. Cl. CPC G09G 3/32; G09G 2330/045

(57) ABSTRACT

Provided are a distributed drive circuit, control method and display device. The circuit comprises a control circuit, drive circuit array, command control interface and read-back line. The array comprises a plurality of drive circuit groups, and each drive circuit group comprises a plurality of drive circuits; the control circuit is used for sending a control signal and a command signal to the drive circuit; the command control interface is used for outputting signals sent by the control circuit for transmission to the drive circuit; the drive circuit is used for driving the light-emitting element in response to the control signal, and is also used for selecting a corresponding alarm mode in response to the command signal, and generating read-back data in the alarm mode to the control circuit; the read-back line is used for transmitting the read-back data in alarm mode generated by drive circuit back to the control circuit.

### TECHNICAL FIELD

The application relates to the technical field of display devices, in particular to a distributed drive circuit, control method and display device.

### BACKGROUND

LED is used in many electronic display devices, such as computers, televisions, mobile devices, smart phones, projection systems, billboards and so on.

A display device can contain a large number of LED units, which can be arranged in the display area in the form of an array, each LED unit corresponds to a driver, and these drivers correspond to the same control circuit.

In the prior art, the control circuit and the driver are in the master-slave mode. The control circuit is the master, which initiates read-back status, and the driver is the slave. In order to ensure the normal operation of the display device, the control circuit needs to read back the working status of all drivers all the time, the data processing volume is very large. Moreover, the control circuit needs to read all drivers, which takes up a lot of time, resulting the inability to respond quickly in some special situations, such as the rapid adjustment of VLED voltage and the short-circuit fault trigger in LED area.

### SUMMARY OF THE INVENTION

The application provides a distributed drive circuit, a control method and a display device thereof, aiming at addressing the issue of large data processing volume and slow response speed in the prior art.

In order to solve the above technical problems, the application adopts the following technical solutions.

According to a first aspect of the present application, a distributed drive circuit is provided, including: a control circuit, a drive circuit array, a command control interface, and a read-back line; wherein
the drive circuit array includes a plurality of drive circuit groups, and each drive circuit group includes a plurality of drive circuits;
the control circuit is used for sending a control signal and a command signal to the drive circuit;
the command control interface is arranged in the control circuit, and the command control interface is used for outputting signals sent by the control circuit for transmission to the drive circuit;
the drive circuit is used for driving a light-emitting element in response to the control signal, and is also used for selecting a corresponding alarm mode in response to the command signal, and generating read-back data in the alarm mode to the control circuit; and
the read-back line is used for transmitting the read-back data in the alarm mode generated by the drive circuit back to the control circuit.

Preferably, when the drive circuit has an alarm condition in the alarm mode, the read-back data generated in the alarm mode includes an alarm signal.

Preferably, the control circuit is further configured for sending a query signal to the drive circuit;
the drive circuit is also used for generating read-back data in a query mode in response to
the query signal; and
the read-back line is also used for transmitting the read-back data in the query mode generated by the drive circuit back to the control circuit.

Preferably, the alarm signal includes address information of the drive circuit in case of failure.

Preferably, the control circuit is also used for recording the alarm signal and/or reporting the alarm signal.

Preferably, the control circuit is further used for sending a processing signal to the drive circuit according to the alarm signal, enabling an alarm condition occurring in the drive circuit to be processed.

Preferably, the circuit further includes serial communication lines, wherein the serial communication line is in one-to-one correspondence with the drive circuit group;
the control circuit, the serial communication line and the read-back line form a loop, and the drive circuit of each group is connected in series in the serial communication line; and
the read-back data of the drive circuit is transmitted to the read-back line via the serial communication line.

Preferably, the drive circuit of a second one in each drive circuit group is also used for parsing the read-back data transmitted by a previous drive circuit, and continuously transmitting the parsed read-back data and the read-back data generated by itself.

Preferably, there are a plurality of the alarm modes in each drive circuit.

Preferably, the alarm modes include any one or more of a drive voltage detection mode of light-emitting element, an open circuit detection mode of light-emitting element, a short-circuit detection mode of light-emitting element and an overheat detection mode.

According to a second aspect of the present application, a control method of distributed drive circuit is provided, including:
sending, by a control circuit, a command signal to each drive circuit group;
selecting, by each drive circuit in the drive circuit group, a corresponding alarm mode in response to the command signal, and generating read-back data in the alarm mode to the control circuit; and
receiving, by the control circuit, the read-back data in the alarm mode.

Preferably, when the read-back data in the alarm mode received by the control circuit includes an alarm signal, the method further includes:
sending, by the control circuit, a query signal to the drive circuit group;
generating, by each drive circuit in the drive circuit group, read-back data in a query mode in response to the query signal; and
receiving, by the control circuit, the read-back data in the query mode.

Preferably, when the read-back data in the alarm mode generated by the drive circuit to the control circuit includes an alarm signal, the alarm signal includes address information of the drive circuit in case of failure.

Preferably, the alarm signal is determined by the control circuit:
when the alarm signal is of a first type, recording and/or reporting the alarm signal by the control circuit; and
when the alarm signal is of a second type, sending a processing signal to the drive circuit by the drive circuit, enabling an alarm condition occurring in the drive circuit to be processed.

According to a third aspect of the present application, a display device is provided, including a light-emitting element zone array, a distributed drive circuit; wherein
the light-emitting element zone array includes a plurality of groups of light-emitting element zones, and each group of light-emitting element zones includes a plurality of light-emitting element zones;
the light-emitting element zone is in one-to-one correspondence with the drive circuit; and
the distributed drive circuit is the distributed drive circuit described above.

According to the distributed drive circuit, control method and display device provided by the application, the drive circuit is no longer just a slave, and the control circuit can send a command signal to it and conFig. it into a corresponding alarm mode. In this state, the drive circuit becomes the master, and it can notify the control circuit through interruption, so that the control circuit does not need to actively read back the drive circuit all the time, which reduces the data processing volume of the control circuit.

In an alternative solution of the application, the alarm signal also includes the address information of the failed drive circuit, and the control circuit can find out which drive circuit or the corresponding light-emitting element is out of order by reading back the data in the alarm mode, thus saving time and further reducing its data processing volume.

In an alternative solution of the present application, the control circuit is further configured for sending a processing signal to the drive circuit according to the alarm signal, so as to process the alarm condition of the drive circuit. In this way, the problems that can be solved by itself can be solved by sending processing signals without reporting, thus saving maintenance time.

In an alternative solution of the present application, the alarm modes in the drive circuit may include various modes, and the control circuit can conFig. it as any one of them as required, or can conFig. it as various modes in turn, thus further reducing the data processing volume of the control circuit.

### BRIEF DESCRIPTION OF THE DRAWINGS

In order to explain the technical solution of the embodiments of this application more clearly, the drawings described in the description of the embodiments of this application will be briefly introduced below. Obviously, the drawings in the present application and their accompanying detailed description are directed to merely exemplary embodiments of the application. For those of ordinary skill in this field, other drawings may be obtained according to these drawings without any creative effort.

FIG. 1 is a schematic diagram of a distributed drive circuit according to an embodiment of the present application.

FIG. 2 is a schematic diagram of a drive circuit according to an embodiment of the present application.

FIG. 3 is a circuit diagram of a display device according to an embodiment of the present application.

Reference signs in the drawings are as follows.
1. Control circuit;
11. Command control interface;
2. Drive circuit;
21. Drive voltage detection mode of light-emitting element;
22. Open circuit detection mode of light-emitting element;
23. Short-circuit detection mode of light-emitting element;
24. Overheat detection mode;
25. Multiplexer;
26. Internal control circuit;
27. Communication line;
3. Read-back line;
4. Serial communication line;
5. Light-emitting element zone.

### DETAILED DESCRIPTION OF PREFERRED EMBODIMENTS

The technical solutions in the embodiments of the present application will be clearly and completely described below with reference to the drawings in the embodiments of this application. Obviously, the described embodiments are merely part of the embodiments of this application, not all of them. Based on the embodiments in this application, all other embodiments obtained by those of ordinary skill in the art without creative effort belong to the protection scope of this application.

For the description of the specification of the present application, it should be understood that the orientations or positional relationships indicated by the terms “upper part”, “lower part”, “upper end”, “lower end”, “lower surface” and “upper surface” and the like are based on the orientations or positional relationships shown in the attached drawings, only for convenience of describing the present application and simplifying the description, and do not indicate or imply that the said device or element must have a specific orientation, be constructed or operated in a particular orientation, and therefore cannot be understood as a limitation of the present application.

For the description of the specification of the present application, the terms “first” and “second” are used for descriptive purposes only and cannot be understood as indicating or implying relative importance or implicitly indicating the number of technical features indicated. Thus, a feature defined by “first” or “second” may explicitly or implicitly includes one or more of the features.

For the description of the present application, “plurality” means plural, such as two, three, four, etc., unless otherwise specifically defined.

For the description of the specification of the present application, unless otherwise stated, the term “connection” and the like should be understood in a broad sense. For example, they may be fixedly connected, detachably connected or integrally connected, or may be mechanically connected or electrically connected, or can communicate with one another. Or they may be directly connected or indirectly connected through an intermediate medium. Or it may be internal communication of two elements or the interaction between two elements. For those of ordinary skill in the art, the specific meanings of the above terms in the present application may be understood in specific situations.

The technical solution of the present application will be described in detail with specific embodiments. The following specific embodiments can be combined with one another, and the same or similar concepts or processes may not be repeated in some embodiments.

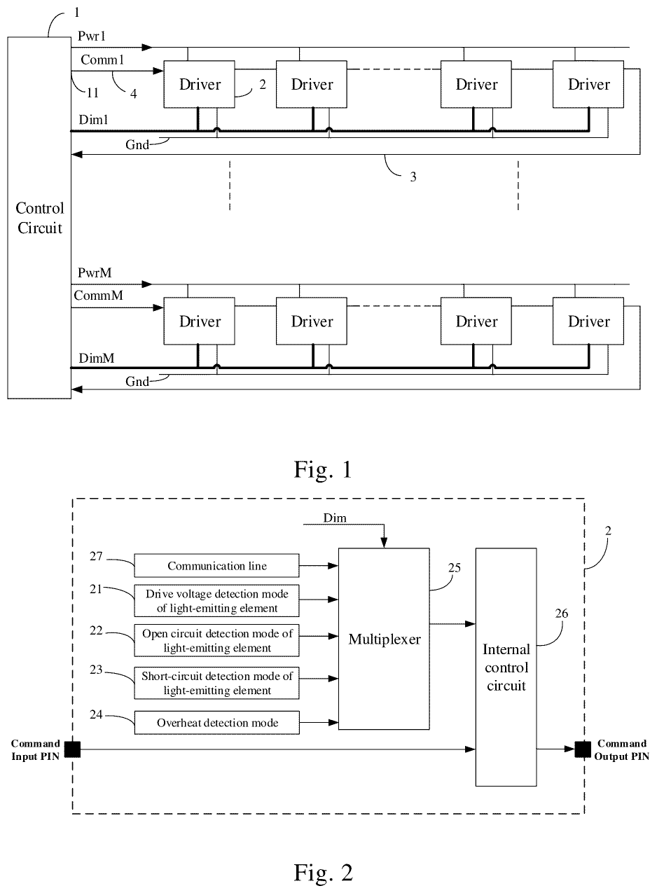

In an embodiment, a distributed drive circuit is provided, which includes a control circuit 1, a drive circuit array, a command control interface 11, and a read-back line 3, as shown in FIG. 1. The drive circuit array includes a plurality of drive circuit groups, and each drive circuit group includes a plurality of drive circuits 2. The control circuit 1 is used for sending a control signal and a command signal to the drive circuit 2. The command control interface 11 is arranged in the control circuit 1, and the command control interface 11 is used for outputting signals sent by the control circuit 1 for transmission to the drive circuit. The drive circuit 2 is used for driving the light-emitting element in response to the control signal, and is also used for selecting a corresponding alarm mode in response to the command signal. In the alarm mode, the drive circuit is no longer a slave, but a master, and can actively generate read-back data in the alarm mode to the control circuit. At this point, the control circuit 1 no longer needs to query the drive circuits one by one. The read-back line 3 is used for transmitting the read-back data in the alarm mode generated by the drive circuit 2 back to the control circuit 1.

In an embodiment, when the drive circuit has an alarm condition in the alarm mode, the read-back data generated in the alarm mode includes an alarm signal.

In an embodiment, when the control circuit receives an alarm signal, the control circuit is further used for sending a query signal corresponding to the alarm mode to the drive circuit of the drive circuit group, so as to confirm which drive circuit or the light-emitting element corresponding to the drive circuit is out of order. The drive circuit is also used for generating read-back data in query mode in response to the query signal. The read-back line is also used for transmitting the read-back data in query mode generated by drive circuit back to control circuit. In an embodiment, the alarm signal also includes address information of the failed drive circuit. That is, the drive circuit also attaches the address information to the generated alarm signal. In this state, after receiving the alarm signal, the control circuit can find out which drive circuit or the light-emitting element corresponding to the drive circuit is faulty, and it is not necessary to query the drive circuits one by one.

In an embodiment, the control circuit is also used for recording the alarm signal and/or reporting alarm signal, so as to facilitate the proceeding stage to be informed of the fault information in time and arrange timely maintenance.

In an embodiment, the control circuit can find out which drive circuit or the light-emitting element corresponding to the drive circuit is out of order by inquiring the drive circuits of the alarmed drive circuit group one by one or by the obtained alarm signal with address information, and report the specific information, so that the maintenance is more accurate.

In another embodiment, the control circuit may not need to find out which drive circuit or the light-emitting element corresponding to the drive circuit is faulty, but only report which drive circuit group is faulty, and then inquire which drive circuit or the light-emitting element corresponding to the drive circuit is faulty during maintenance.

In an embodiment, when the alarm condition appears to be a state that can be solved by the circuit control, the control circuit is also used for sending a processing signal to the drive circuit according to the alarm signal, so as to process the alarm condition occurring in the drive circuit. In this way, it can be solved by itself without reporting, which is more intelligent and saves workload. For example, when the alarm condition is overheating, the control circuit can send a processing signal to reduce the current of the drive circuit under the alarm condition.

In an embodiment, in order to facilitate the transmission of read-back data, the distributed drive circuit further includes serial communication lines 4 (Comm1, . . . CommM), and the serial communication line 4 is in one-to-one correspondence with the drive circuit group, as shown in FIG. 1. The control circuit 1, serial communication line 4 and read-back line 3 form a loop, and the drive circuit 2 of each group is connected in series in the serial communication line 4. The read-back data of drive circuit is transmitted to read-back line via the serial communication line, and then transmitted back to control circuit via the read-back line.

In an embodiment, the drive circuit of a second one in each drive circuit group is also used for parsing the read-back data transmitted by a previous drive circuit, and continuously transmitting the parsed read-back data and the read-back data generated by itself. The parsing of read-back data can be realized by an internal control circuit 26, as shown in FIG. 2.

The drive circuit 2 includes a serial communication line (command) input pin and a serial communication line (command) output pin. The serial communication line input pin is used for the inlet of serial communication line, and the serial communication line output pin is used for the outlet of serial communication line. The serial communication line input pin is connected with an input end of the internal control circuit 26, and an output end of the internal control circuit 26 is connected with the serial communication line output pin.

In different embodiments, the parsing of read-back data may also be realized by a program. In an embodiment, there are a plurality of alarm modes in each drive circuit, and the control circuit can conFig. each drive circuit group as one of the alarm modes as required. Alternatively, the control circuit can conFig. the alarm modes of each drive circuit group in turn. For example, when there are 3 alarm modes: the first alarm mode, second alarm mode and third alarm mode, and the control circuit can control the drive circuit to take turns among the three modes. At the same time, each row of drive circuit groups in the drive circuit array can be configured in the same alarm mode or in different alarm modes.

In an embodiment, the alarm modes may include any one or more of a drive voltage detection mode of light-emitting element, an open circuit detection mode of light-emitting element, a short-circuit detection mode of light-emitting element and an overheat detection mode. It should be noted that the alarm modes in the above embodiments are just examples, and other alarm modes may be designed according to actual needs under different circumstances.

The alarm modes include: drive voltage detection mode of light-emitting element 21, open circuit detection mode of light-emitting element 22, short-circuit detection mode of light-emitting element 23, overheat detection mode 24, as shown in FIG. 2. In this embodiment, the command control interface 11 sends a command signal to a multiplexer 25 via Dim line (Dim1, . . . DimM), and the multiplexer 25 selects a corresponding alarm mode according to the command signal.

In different embodiments, the selection of alarm mode may also be realized by program.

In an embodiment, when the internal control circuit 26 is included in the drive circuit 2, the multiplexer 25 is connected to the input end of the internal control circuit 26, as shown in FIG. 2. In an embodiment, when the control circuit 1 sends a query signal to the drive circuit, the multiplexer 25 further includes a communication line 27, as shown in FIG. 2. In this state, the drive circuit 2 is merely a conventional communication line, as a slave.

In an embodiment, a control method of distributed drive circuit is also provided, which includes:
sending a command signal to each drive circuit group by a control circuit; selecting, by each drive circuit in the drive circuit group, a corresponding alarm mode in response to the command signal, and generating read-back data in the alarm mode to the control circuit; and
receiving the read-back data in the alarm mode by the control circuit.

In an embodiment, when the read-back data in the alarm mode received by the control circuit includes an alarm signal, the method further includes:
sending a query signal to the drive circuit group by the control circuit;
generating, by each drive circuit in the drive circuit group, read-back data in a query mode in response to the query signal; and
receiving the read-back data in the query mode by the control circuit.

In an embodiment, when the read-back data in the alarm mode generated by the drive circuit to the control circuit includes an alarm signal, the alarm signal includes address information of the drive circuit in case of failure.

In an embodiment, the alarm signal is determined by the control circuit:
when the alarm signal is of a first type, such as short circuit, open circuit and other physical faults that the control circuit cannot solve by itself, recording and/or reporting the alarm signal by the control circuit; and
when the alarm signal is of a second type, such overheating and other logical faults that the control circuit can solve by itself, sending a processing signal to the drive circuit by the drive circuit, enabling an alarm condition occurring in the drive circuit to be processed. For example, when an overheating alarm occurs, the control circuit can send a current reduction signal to the drive circuit where the overheating alarm occurs, so that the overheating condition of the drive circuit can be handled.

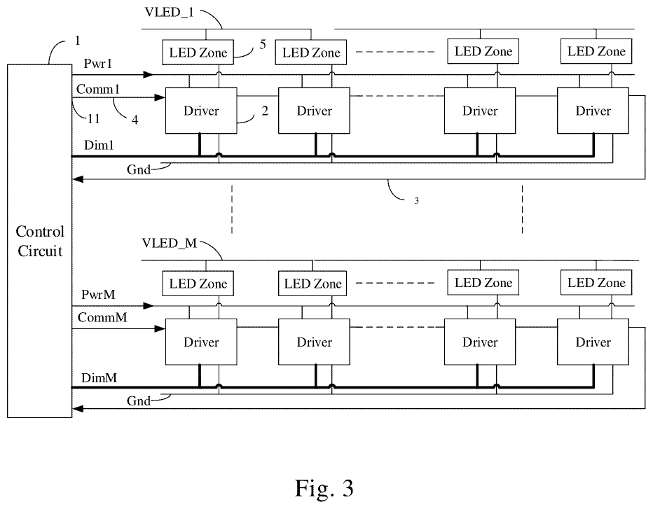

In an embodiment, a display device is also provided, as shown in FIG. 3, which includes a light-emitting element zone array, a distributed drive circuit. The light-emitting element zone array includes a plurality of groups of light-emitting element zones, and each group of light-emitting element zones includes a plurality of light-emitting element zones. The light-emitting element zone is in one-to-one correspondence with the drive circuit. The distributed drive circuit is the distributed drive circuit described in any of the above embodiments. The drive circuit drives the corresponding light-emitting element zone in response to the control signal of the control circuit, so as to control whether it emits light and/or the brightness of the light.

In an embodiment, a light-emitting diode (LED) is taken as an example for the light-emitting element, and the light-emitting element zone 5 is an LED Zone, as shown in FIG. 3.

The display device may also include a VLED line (e.g., VLED__1 . . . VLED__M), a power communication line Pwr (e.g., Pwr1 . . . PwrM), and a ground line Gnd. The VLED line is used to supply power to the LED zone, the power communication line Pwr is used to supply power to the drive circuit, and the ground line Gnd provides a grounding path for the LED zone and the drive circuit 2.

In this specification, descriptions referring to the phrases “an implementation”, “an embodiment”, “a specific implementation process” and “an example” mean that specific features, structures, materials or characteristics described in connection with the embodiment or example are included in at least one embodiment or example of the present application. In this specification, the schematic expressions of the above phrases do not necessarily refer to the same embodiment or example. Moreover, the specific features, structures, materials or characteristics described may be combined in any one or more embodiments or examples in a appropriate manner.

The above embodiments are only used to illustrate the technical solutions of this application, but not to limit it. Although the application has been described in detail with reference to the aforementioned embodiments, those of ordinary skill in the art should understand that the technical solutions described in the aforementioned embodiments may still be modified, or some of the technical features may be equivalently replaced. However, these modifications or substitutions do not make the essence of the technical solutions deviate from the scope of the technical solutions of each embodiment of this application.

1. A distributed drive circuit, comprising: a control circuit, a drive circuit array, a command control interface, and a read-back line; wherein
the drive circuit array comprises a plurality of drive circuit groups, and each drive circuit group comprises a plurality of drive circuits;
the control circuit is used for sending a control signal and a command signal to the drive circuit;
the command control interface is arranged in the control circuit, and the command control interface is used for outputting signals sent by the control circuit for transmission to the drive circuit;
the drive circuit is used for driving a light-emitting element in response to the control signal, and is also used for selecting a corresponding alarm mode in response to the command signal, and generating read-back data in the alarm mode to the control circuit; and
the read-back line is used for transmitting the read-back data in the alarm mode generated by the drive circuit back to the control circuit.

2. The distributed drive circuit of claim 1, wherein when the drive circuit has an alarm condition in the alarm mode, the read-back data generated in the alarm mode comprises an alarm signal.

3. The distributed drive circuit of claim 2, wherein the control circuit is further configured for sending a query signal to the drive circuit;
the drive circuit is also used for generating read-back data in a query mode in response to the query signal; and
the read-back line is also used for transmitting the read-back data in the query mode generated by the drive circuit back to the control circuit.

4. The distributed drive circuit of claim 2, wherein the alarm signal comprises address information of the drive circuit in case of failure.

5. The distributed drive circuit of claim 1, wherein the control circuit is also used for recording the alarm signal and/or reporting the alarm signal.

6. The distributed drive circuit of claim 1, wherein the control circuit is further used for sending a processing signal to the drive circuit according to the alarm signal, enabling an alarm condition occurring in the drive circuit to be processed.

7. The distributed drive circuit of claim 4, further comprising serial communication lines, wherein the serial communication line is in one-to-one correspondence with the drive circuit group;
the control circuit, the serial communication line and the read-back line form a loop, and the drive circuit of each group is connected in series in the serial communication line; and
the read-back data of the drive circuit is transmitted to the read-back line via the serial communication line.

8. The distributed drive circuit of claim 7, wherein the drive circuit of a second one in each drive circuit group is also used for parsing the read-back data transmitted by a previous drive circuit, and continuously transmitting the parsed read-back data and the read-back data generated by itself.

9. The distributed drive circuit of claim 1, wherein there are a plurality of the alarm modes in each drive circuit.

10. The distributed drive circuit of claim 1, wherein the alarm modes include any one or more of a drive voltage detection mode of light-emitting element, an open circuit detection mode of light-emitting element, a short-circuit detection mode of light-emitting element and an overheat detection mode.

11. A control method of distributed drive circuit, comprising:
sending, by a control circuit, a command signal to each drive circuit group;
selecting, by each drive circuit in the drive circuit group, a corresponding alarm mode in response to the command signal, and generating read-back data in the alarm mode to the control circuit; and
receiving, by the control circuit, the read-back data in the alarm mode.

12. The control method of distributed drive circuit of claim 11, wherein when the read-back data in the alarm mode received by the control circuit comprises an alarm signal, the method further comprises:
sending, by the control circuit, a query signal to the drive circuit group;
generating, by each drive circuit in the drive circuit group, read-back data in a query mode in response to the query signal; and
receiving, by the control circuit, the read-back data in the query mode.

13. The control method of distributed drive circuit of claim 11, wherein when the read-back data in the alarm mode generated by the drive circuit to the control circuit comprises an alarm signal, the alarm signal comprises address information of the drive circuit in case of failure.

14. The control method of distributed drive circuit of claim 1, wherein the alarm signal is determined by the control circuit:
when the alarm signal is of a first type, recording and/or reporting the alarm signal by the control circuit; and
when the alarm signal is of a second type, sending a processing signal to the drive circuit by the drive circuit, enabling an alarm condition occurring in the drive circuit to be processed.

15. A display device, comprising a light-emitting element zone array, a distributed drive circuit; wherein the light-emitting element zone array comprises a plurality of groups of light-emitting element zones, and each group of light-emitting element zones comprises a plurality of light-emitting element zones;
the light-emitting element zone is in one-to-one correspondence with the drive circuit; and
the distributed drive circuit is the distributed drive circuit of claim 1.
